(19) United States
(12) Patent Application Publication
(10) Pub. No.: US 2023/0228389 A1
(43) Pub. Date: Jul. 20, 2023

(54) MULTIDIRECTIONAL SPLICING LIGHTING ATMOSPHERE ILLUMINATION MODULE AND MODULAR ILLUMINATION DEVICE THEREOF

(71) Applicants: Jie LI, Guangdong (CN); YaKe LUO, Guangdong (CN); MingHai MA, Guangdong (CN); XiaoKe LI, Guangdong (CN); XiaoQi MA, Guangdong (CN)

(72) Inventors: Jie LI, Guangdong (CN); YaKe LUO, Guangdong (CN); MingHai MA, Guangdong (CN); XiaoKe LI, Guangdong (CN); XiaoQi MA, Guangdong (CN)

(21) Appl. No.: 17/584,417

(22) Filed: Jan. 26, 2022

(30) Foreign Application Priority Data
Jan. 19, 2022 (CN) 202220140945.3

(51) Int. Cl. F21S 2/00; F21V 23/06; F21V 17/16

(52) U.S. Cl. CPC F21S 2/005; F21V 23/06; F21V 17/16; F21Y 2115/10

(57) ABSTRACT

The present application provides a multidirectional splicing lighting atmosphere illumination module, which comprises a module bottom shell, an LED lamp panel installed on the module bottom shell and a module cover installed on the module bottom shell. The present application further provides a modular illumination device, which comprises multidirectional splicing lighting atmosphere illumination modules and connecting buckles, and the two adjacent illumination modules are in electrical and signal connection through the connecting buckles. The problems of electrical and signal connection and mechanical splicing of the two adjacent illumination modules are solved by buckling the connecting buckles with the two adjacent illumination modules, at the same time, the plurality of illumination modules can be assembled and combined into different shapes to realize different lighting decoration effects, and then the present application has the advantages of repeated splicing.

### CROSS-REFERENCE TO RELATED APPLICATIONS

This application claims the benefit and priority of Chinese patent application No. 2022201409453, filed on Jan. 19, 2022, disclosure of which is hereby incorporated by reference in its entirety.

### BACKGROUND OF THE INVENTION

The present application relates to the field of lighting decoration and illumination, in particular to a multidirectional splicing lighting atmosphere illumination module and a modular illumination device thereof.

The illumination module in the existing market usually adopts an LED (Light-emitting Diode) lamp bead illumination solution and is formed by combining a plurality of LED lamp beads. In addition, batches of illumination modules may be assembled into a modular illumination device, so as to adapt to the needs of lighting decoration atmosphere and illumination in different occasions.

At present, the splicing between the illumination modules adopts the side parallel plug connection, and the spliced illumination modules are directly fixed on an installation wall, so the illumination modules are inconvenient for unplugging vertically after installation, specifically, due to inability of independent unplugging, the illumination module in a middle position has the problems of difficult maintenance and replacement and hard to realize the repeated splicing of the illumination module.

In addition, the illumination modules of the illumination device are in electrical and signal connection, so the power supply and signal control of the LED light in the illumination device may be realized by leading out electrical and signal connecting lines from the illumination modules or connecting the electrical and signal connecting lines to a circuit board with a logical function. On the one hand, the structure of the illumination module is not beautiful, and on the other hand, the illumination modules may be inconvenient for splicing various shapes due to difficult installation.

### BRIEF SUMMARY OF THE INVENTION

Aiming at overcoming the above defects in the prior art, the present application provides a multidirectional splicing lighting atmosphere illumination module and a modular illumination device, which can solve the problem that the structure of the illumination module needs to externally lead out the electrical and signal connecting lines. The structure of the illumination module is simple and beautiful, so the problem of electrical and signal connection among the illumination modules in the illumination device is also solved, users can install the illumination modules conveniently, and various shapes can be spliced conveniently and repeated splicing can be realized.

In order to implement the above purpose, the present application provides the technical solution below:

According to a first aspect, the present application provides a multidirectional splicing lighting atmosphere illumination module and a modular illumination device, the multidirectional splicing lighting atmosphere illumination module comprises a module bottom shell, an LED lamp panel installed on the module bottom shell and a module cover installed on the module bottom shell. A plurality of electrical and signal connecting port hole sites are formed at the bottom of the module bottom shell, and a plurality of electrical and signal connecting ports that correspond to the electrical and signal connecting port hole sites are formed on the LED lamp panel.

Preferably, the multidirectional splicing lighting atmosphere illumination module further comprises an installation base that is detachably connected to the bottom of the module bottom shell. In this embodiment, a plurality of buckles are installed at the bottom of the module bottom shell, the module bottom shell is in buckling connection with the installation base by the buckles, so that the illumination module on the installation base are conveniently pulled and buckled in a direction perpendicular to the installation wall, specifically the illumination module in the middle position is very convenient to take down and replace.

Preferably, the bottom of the installation base is provided with double-sided adhesive or screw, which solves the problem that the installation base of the illumination module is attached to the installation wall, so the installation base has the advantages of ensuring the installation stability and not harming the installation wall.

Preferably, the module bottom shell is a triangular, quadrangular or hexagonal structure. Different outline structures are provided to the module bottom shell, so that users can perform different shapes of creative collocation and assembly on different outlines of illumination modules.

According to a second aspect, a modular illumination device comprises a plurality of multidirectional splicing lighting atmosphere illumination modules and connecting buckles, and the two adjacent illumination modules are in electrical and signal connection through the connecting buckles. Each connecting buckle comprises a connecting buckle clamp, one end of which is provided with a first elastic contact connector and the other end is provided with a second elastic contact connector. The first elastic contact connector is inserted into the electrical and signal connecting port hole site of one illumination module of the two adjacent illumination modules and in electrical and signal connection with the electrical and signal connecting port corresponding to the electrical and signal connecting port hole site, and the second elastic contact connector is inserted into the electrical and signal connecting port hole site of the other illumination module of the two adjacent illumination modules and in electrical and signal connection with the electrical and signal connecting port corresponding to the electrical and signal connecting port hole site.

Preferably, a first buckle block that is in buckling connection with the electrical and signal connecting port hole site of one illumination module of the two adjacent illumination modules is installed at one end of the connecting buckle clamp, and a second buckle block that is in buckling connection with the electrical and signal connecting port hole site of the other illumination module of the two adjacent illumination modules is installed at the other end of the connecting buckle clamp.

Preferably, the modular illumination device further comprises a PCB circuit board installed on the connecting buckle clamp. One end of the PCB circuit board is electrically connected to the first elastic contact connector, and the other end of the PCB circuit board is electrically connected to the second elastic contact connector.

Compared with the prior art, the present application has the following beneficial effects:

1. The present application is provided with a module bottom shell, in which an LED lamp panel is installed, and electrical and signal connecting port hole sites are formed at the bottom of the module bottom shell. The electrical and signal connecting ports of the LED lamp panel correspond to the electrical and signal connecting port hole sites at the same time, and this structural setting solves the problem that the structure of the illumination module needs to externally lead out the electrical and signal connecting line, and the illumination module has the advantages of beautiful and simple structure.

2. The present application is provided with an illumination module, and the problems of electrical and signal connection and mechanical splicing between the two adjacent illumination modules are solved by buckling the connecting buckle with the two adjacent illumination modules. The illumination module and the connecting buckle are simply installed and pulled, and specifically the illumination module at the middle position has the advantages of easy replacement and realizing repeated splicing.

3. The present application provides a multidirectional splicing lighting atmosphere illumination module and a modular illumination device thereof, so that the batches of illumination modules of the illumination device may be assembled into different shapes according to users' needs, and implement the different lighting decoration effects.

### BRIEF DESCRIPTION OF THE DRAWINGS

To better clarify the embodiments of the present application or the technical solution of the prior art, the accompanying drawings required to illustrate the embodiments or the prior art will be simply described below. Obviously, the accompanying drawings described below illustrate some embodiments of the utility model. Those ordinarily skilled in the art can obtain other drawings of other embodiments without creative labor on the basis of those drawings.

FIG. 1 is a schematic diagram of a decomposition structure of a multidirectional splicing lighting atmosphere illumination module provided by the present application.

FIG. 2 is a structural schematic diagram of a module bottom shell and an LED lamp panel provided by the present application.

FIG. 3 is a structural schematic diagram of two adjacent illumination modules in a modular illumination device provided by the present application.

FIG. 4 is a structural schematic diagram of a connecting buckle provided by the present application.

FIG. 5 is a structural schematic diagram of a connecting buckle clamp, a PCB circuit board and a terminal component provided by the present application.

FIG. 6 is a schematic diagram for a decomposition structure of a quadrangular illumination module in one embodiment provided by the present application.

FIG. 7 is a schematic diagram for a decomposition structure of a hexagonal illumination module in one embodiment provided by the present application.

FIG. 8 is a circuit diagram of a circuit principle in a second solution provided by the present application.

FIG. 9 is a circuit diagram of a circuit principle in two adjacent illumination modules controlled by 12V power in a second solution provided by the present application.

FIG. 10 is an internal block diagram of a drive and control IC (Integrated Circuit) of an unipolar return-to-zero code communication method provided by the present application.

FIG. 11 is a structural schematic diagram for splicing a triangular illumination module into one shape in one embodiment provided by the present application.

FIG. 12 is a structural schematic diagram for splicing a hexagonal illumination module into one shape in one embodiment provided by the present application.

FIG. 13 is a structural schematic diagram for splicing a quadrangular illumination module and a hexagonal illumination module into one shape in one embodiment provided by the present application.

In the drawings:

1. Module base shell; 2. LED lamp panel; 3. Module cover; 4. Electrical and signal connecting port hole sites; 5. Electrical and signal connecting ports; 6. Chamfer guide portion; 7. Installation base; 8. Connecting buckles; 9. Connecting buckle clamp; 10. First elastic contact connector; 11. Second elastic contact connector; 12. First buckle block; 13. Second buckle block; 14. Terminal component; 15. PCB circuit board.

### DETAILED DESCRIPTION OF THE INVENTION

The technical solutions in the embodiments of the present application are clearly and completely elaborated below in combination with the accompanying drawings in the embodiments of the present application. It is apparent that the described embodiments are only one implementation mode of the present application but not all. Based on the implementation mode of the present application, all the other implementation modes obtained by those of ordinary skill in the art on the premise of not contributing creative effort should belong to the protection scope of the present application.

### Embodiment 1

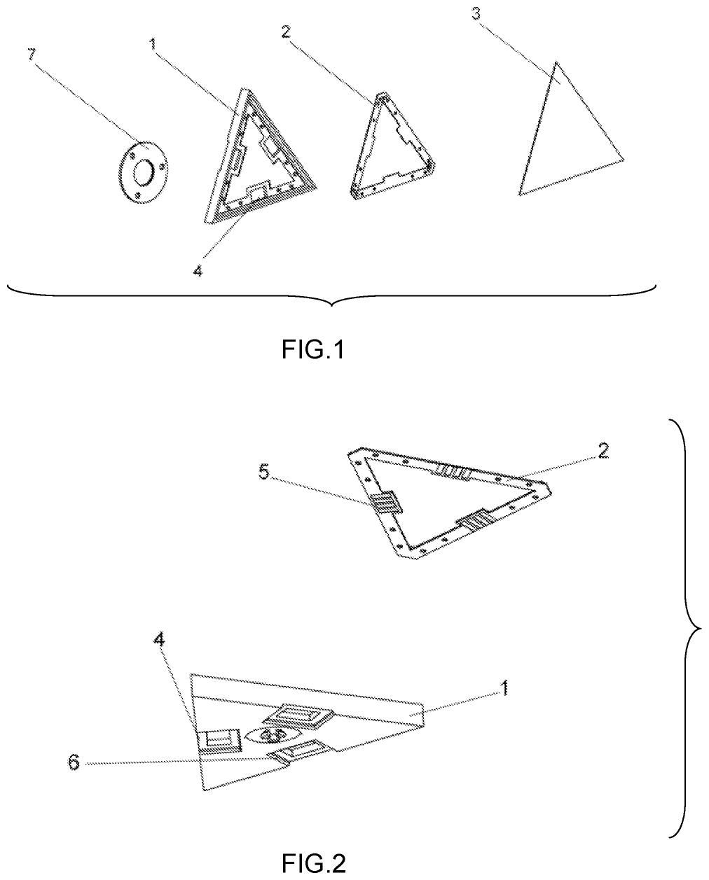

Referring to FIG. 1-FIG. 2, the present application provides a multidirectional splicing lighting atmosphere illumination module, which comprises a module bottom shell 1, an LED lamp panel 2, a module cover 3 and an installation base 7, the LED lamp panel 2 is installed in the module bottom shell 1, the module cover 3 is buckled at the top of the module bottom shell 1, and the installation base 7 is installed at the bottom of the module bottom shell 1.

A plurality of electrical and signal connecting port hole sites 4 are formed at the bottom of the module bottom shell 1, and a plurality of electrical and signal connecting ports 5 that correspond to the electrical and signal connecting port hole sites are formed on the LED lamp panel 2.

The bottom of the module bottom shell 1 is detachably connected to the installation base 7. In this embodiment, a plurality of buckles are arranged at the bottom of the module bottom shell 1, and the module bottom shell 1 is in buckling connection with the installation base 7 through the buckles. In other embodiments, a magnet may be installed at the bottom of the module bottom shell 1, and the module bottom shell 1 is absorbed with the installation base 7 through the magnet.

In this embodiment, the bottom of the installation base 7 may be installed on the installation wall through the double-sided adhesive, which has strong extensibility, and the purpose of setting the double-sided adhesive with strong extensibility is as follows: when the installation base 7 is installed on the installation wall, the double-sided adhesive with strong extensibility extends out of the bottom edge of the installation base 7; when the module bottom shell 1 needs to be taken down from the installation wall, the module bottom shell 1 can be pulled from a direction perpendicular to the installation wall, so that the bottom buckle of the module bottom shell 1 is separated from the installation base 7, then the double-sided adhesive with strong extensibility at the bottom of the installation base 7 is pulled out, namely, the installation base 7 is easily separated from the installation wall without damaging the installation wall. In other embodiments, the bottom of the installation base 7 may be fixedly connected to the installation wall through screw or other fixed methods.

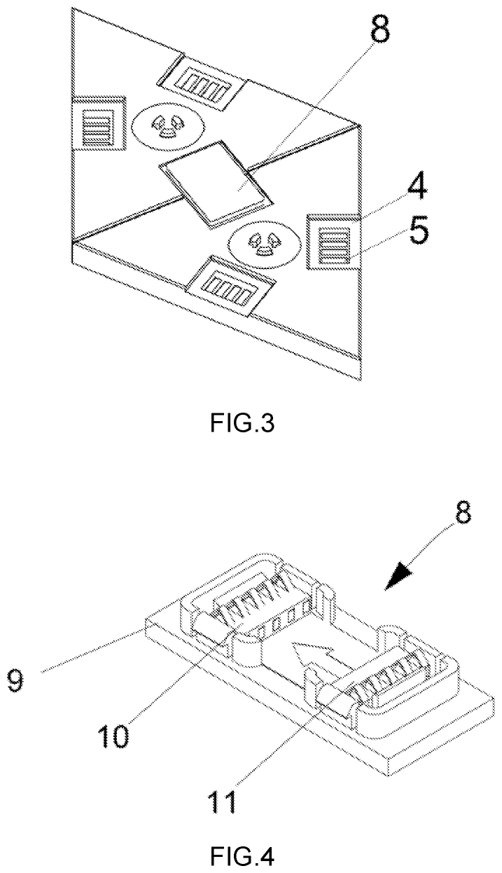

Referring to FIG. 3, which is a structural schematic diagram of two adjacent illumination modules in a modular illumination device provided by the present application, wherein FIG. 3 clearly illustrates that the two adjacent illumination modules are connected together by the connecting buckle 8, and the structural schematic diagram is convenient for understanding the contents below.

The purpose of the detachable connection setting of the module bottom shell 1 and the installation base 7 and the setting of the bottom of the installation base 7 and the installation wall is that the illumination module is conveniently pulled out or buckled in the direction perpendicular to the installation wall, specifically, the illumination module in the middle position is conveniently taken down and replaced.

In this embodiment, the module cover 3 is set as a transparent surface cover.

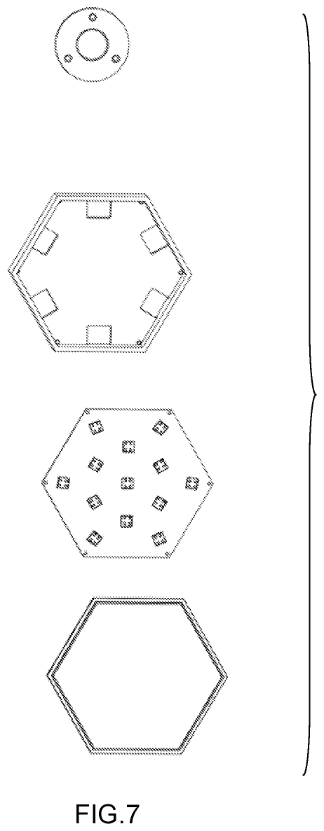

The structure of the module bottom shell 1 is the appearance structure of the illumination module. In this embodiment, the structure of the illumination module is triangular, and in other embodiments, the structure of the illumination module may be quadrangular, hexagonal, polygonal or other irregular shapes. For example, referring to FIG. 6, which is a schematic diagram for a decomposition structure of a quadrangular illumination module, and referring to FIG. 7, which is a schematic diagram for decomposition structure of a hexagonal illumination module.

### Embodiment 2

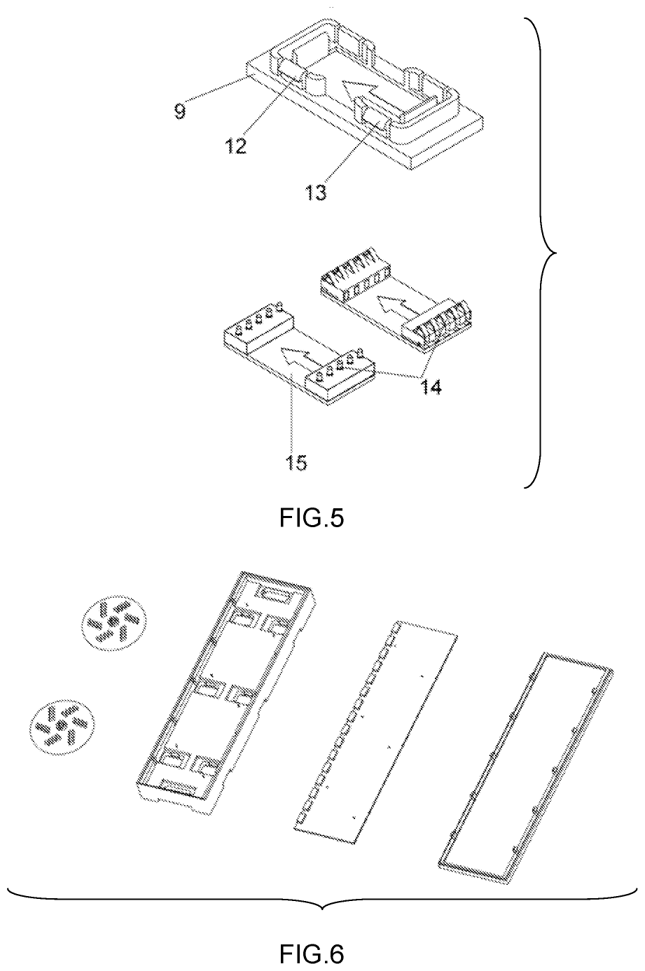

Referring to FIG. 2-FIG. 5, this embodiment provides a modular illumination device, which comprises a multidirectional splicing lighting atmosphere illumination module and a connecting buckle in the embodiment 1.

Referring to FIG. 3, the two adjacent illumination modules are in electrical and signal connection through the connecting buckle 8.

The connecting buckle 8 comprises a connecting buckle clamp 9, one end of which is provided with a first elastic contact connector 10 and the other end is provided with a second elastic contact connector 11. The first elastic contact connector 10 is inserted into the electrical and signal connecting port hole site 4 of one illumination module of the two adjacent illumination modules and in electrical and signal connection with the electrical and signal connecting port 5 corresponding to the electrical and signal connecting port hole site 4, and the second elastic contact connector 11 is inserted into the electrical and signal connecting port hole site 4 of the other illumination module of the two adjacent illumination modules and in electrical and signal connection with the electrical and signal connecting port 5 corresponding to the electrical and signal connecting port hole site 4.

A first buckle block 12 that is in buckling connection with the electrical and signal connecting port hole site 4 of one illumination module of the two adjacent illumination modules is installed at one end of the connecting buckle clamp 9, and a second buckle block 13 that is in buckling connection with the electrical and signal connecting port hole site 4 of the other illumination module of the two adjacent illumination modules is installed at the other end of the connecting buckle clamp 9.

And then, referring to FIG. 2, a chamfer guide portion 6 is arranged at the electrical and signal connecting port hole site 4 at the bottom of the module bottom shell 1. In the direction perpendicular to the installation wall, a first buckle block 12 contacts with the chamfer guide portion 6 firstly during a process that the first buckle block 12 is buckled with the electrical and signal connecting port hole site 4 of one illumination module of the two adjacent illumination modules. The buckling force increases in a vertical direction, so that the elastic buckling portions at the two ends of the first buckle block 12 may deform and narrow down, and be continuously imported from a narrow opening of the chamfer guide portion 6, and then the buckling between the first buckling block 12 and the electrical and signal connecting port hole site 4 of one illumination module is completed. Similarly, the buckling between the second buckling block 13 and the electrical and signal connecting port hole site 4 of the other illumination module of the two adjacent illumination modules is completed.

The purpose of setting the first buckling block 12 and the second buckling block 13 is that the connecting buckle 8 and the illumination module are conveniently pulled out or buckled in the direction perpendicular to the installation wall, specifically, the illumination module in the middle position is conveniently taken down and replaced.

The first elastic contact connector 10 and the second elastic contact connector 11 respectively comprise a rubber core and a terminal component 14 integrally formed with the rubber core, and the terminal component 14 is composed of a plurality of reeds or spring needles.

A PCB circuit board 15 is installed on the connecting buckle clamp 9, one end of the PCB circuit board is electrically connected to the first elastic contact connector 10, and the other end of the PCB circuit board is electrically connected to the second elastic contact connector 11.

### Embodiment 3

This embodiment provides circuit implementation of the electrical and signal connecting between the multidirectional splicing lighting atmosphere illumination modules in the modular illumination device.

Firstly, the circuit implementation of the electrical and signal connecting between the two adjacent illumination modules has a plurality of solutions; for example, a multidirectional splicing lighting atmosphere illumination module may adopt an LED-IC integrated sealing lamp bead or an integrated IC+ control LED lamp bead solution with the unipolar return-to-zero code communication method. When the integrated IC+ control LED lamp bead solution with the unipolar return-to-zero code communication method is adopted between the two adjacent illumination modules, two solutions are formed:

Solution 1: the integrated IC is arranged in the illumination module, and the integrated IC installed on the LED lamp panel 2 is provided with a signal input end and a signal output end, the connecting buckle 8 is in buckling connection in any direction, and the electrical and signal connecting port 5 on the integrated IC needs to identify a signal serial direction;

Solution 2: the integrated IC is arranged in the illumination module, and all electrical and signal connecting ports 5 of the integrated IC installed on the LED lamp panel 2 are connected in parallel, the connecting buckle 8 needs to identify the signal serial direction when in buckling connection, and the electrical and signal connecting port 5 on the integrated IC does not needs to identify the direction.

In this embodiment, the circuit implementation in the second solution is specifically described.

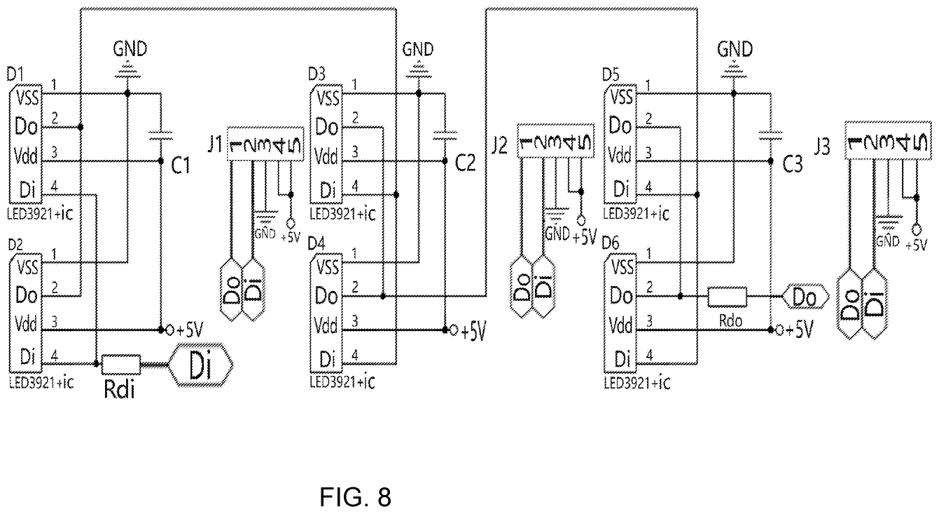

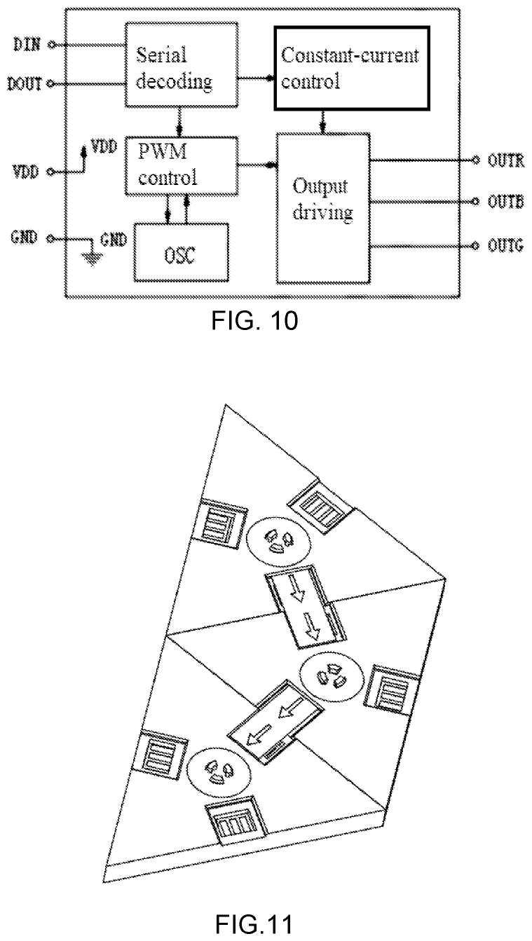

Referring to FIG. 8-FIG. 10, the power circuit connecting and signal transmission principle of the two adjacent illumination modules is as follows: when the illumination module is set that all electrical and signal connecting ports 5 of the integrated IC installed on the LED lamp panel 2 are connected in parallel, the connecting buckle 8 is set as a serial cascade interface of which the signal has a transmission direction. And then, the two adjacent illumination modules realize the signal transmission through the serial cascade interface, namely, the communication and decoding are completed, at the same time, the two adjacent illumination modules realize the parallel connection of the power circuit. At this time, the modular illumination device realizes the logical function that batches of illumination modules can complete the illumination of different orders by a setting program, thereby achieving the function of lighting decoration and mobilizing the atmosphere.

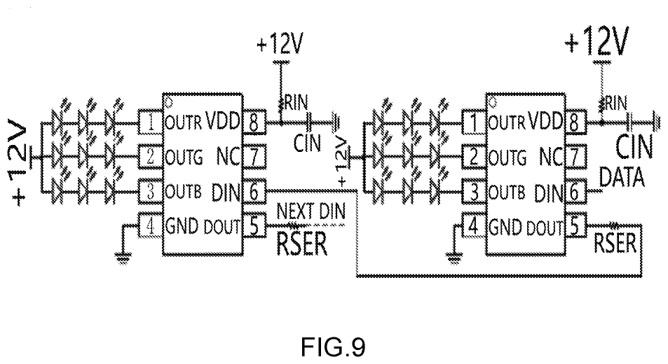

Referring to FIG. 9, in this embodiment, FIG. 9 provides a circuit diagram of a circuit principle in two adjacent illumination modules controlled by 12V power. In other embodiments, the illumination modules with different specifications may be driven by 5V, 24V or other voltage, which can be set by users.

In the second solution, the circuit implementation between the multidirectional splicing lighting atmosphere illumination modules in the modular illumination device has simple circuit, mature intelligent control method and short second development period, and the comprehensive cost is greatly reduced. Moreover, the illumination module and the connecting buckle 8 are conveniently disassembled, specifically the illumination module in the middle position is easily taken down.

### Embodiment 4

The present application provides a modular illumination device, of which the batches of illumination modules may be assembled into different shapes.

For example, referring to FIG. 11, which is a structural schematic diagram for splicing a triangular illumination module into one shape in one embodiment.

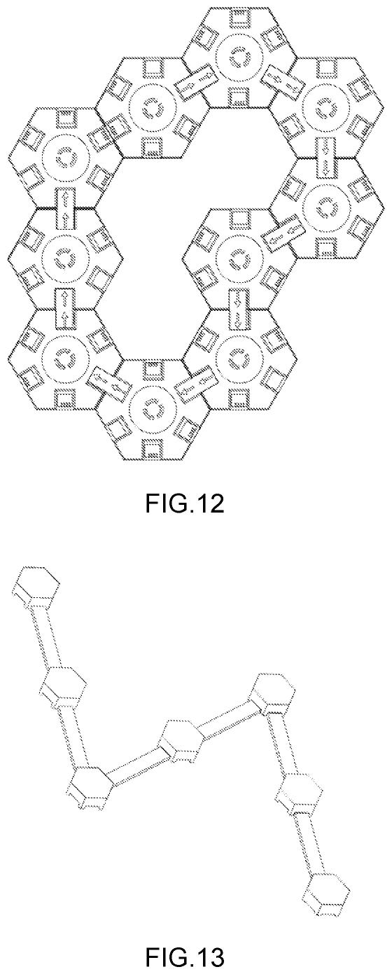

Referring to FIG. 12, which is a structural schematic diagram for splicing a hexagonal illumination module into one shape in one embodiment.

Referring to FIG. 13, which is a structural schematic diagram for splicing a quadrangular illumination module and a hexagonal illumination module into one shape in one embodiment.

In conclusion, the modular illumination device can be assembled and combined into different shapes according to user needs, which is convenient for users to install and disassemble, and convenient for users to achieve different lighting decoration effects and repeated assembly.

The above is only optional embodiments of the present application and not intended to limit the present application. Any modifications, equivalent replacements, improvements and the like made within the spirit and principle of the present application shall fall within the protection scope of the present application.

1. A multidirectional splicing lighting atmosphere illumination module, wherein the multidirectional splicing lighting atmosphere illumination module comprises a module bottom shell (1), an LED lamp panel (2) installed on the module bottom shell (1) and a module cover (3) installed on the module bottom shell (1), a plurality of electrical and signal connecting port hole sites (4) are formed at the bottom of the module bottom shell (1), and a plurality of electrical and signal connecting ports (5) that correspond to the electrical and signal connecting port hole sites (4) are formed on the LED lamp panel (2); the multidirectional splicing lighting atmosphere illumination module further comprises an installation base (7) that is detachably connected to the bottom of the module bottom shell (1).

2. (canceled)

3. The multidirectional splicing lighting atmosphere illumination module according to claim 1, wherein the bottom of the installation base (7) is provided with double-sided adhesive or screw.

4. The multidirectional splicing lighting atmosphere illumination module according to claim 1, wherein the module cover (3) is a transparent surface cover, and in buckling connection with the top of the module bottom shell (1).

5. The multidirectional splicing lighting atmosphere illumination module according to claim 1, wherein the module bottom shell (1) is a triangular, quadrangular or hexagonal structure.

6. A modular illumination device, wherein the modular illumination device comprises a plurality of multidirectional splicing lighting atmosphere illumination modules and connecting buckles (8) according to any one of claim 1, the two adjacent illumination modules are in electrical and signal connection through the connecting buckles (8), each connecting buckle (8) comprises a connecting buckle clamp (9), one end of which is provided with a first elastic contact connector (10) and the other end is provided with a second elastic contact connector (11), the first elastic contact connector (10) is inserted into the electrical and signal connecting port hole site (4) of one illumination module of the two adjacent illumination modules and in electrical and signal connection with an electrical and signal connecting port (5) corresponding to the electrical and signal connecting port hole site (4), and the second elastic contact connector (11) is inserted into the electrical and signal connecting port hole site (4) of the other illumination module of the two adjacent illumination modules and in electrical and signal connection with the electrical and signal connecting port (5) corresponding to the electrical and signal connecting port hole site (4).

7. The modular illumination device according to claim 6, wherein a first buckle block (12) that is in buckling connection with the electrical and signal connecting port hole site (4) of one illumination module of the two adjacent illumination modules is installed at one end of the connecting buckle clamp (9), and a second buckle block (13) that is in buckling connection with the electrical and signal connecting port hole site (4) of the other illumination module of the two adjacent illumination modules is installed at the other end of the connecting buckle clamp (13).

8. The modular illumination device according to claim 6, wherein the first elastic contact connector (10) and the second elastic contact connector (11) respectively comprise a rubber core and a terminal component (14) integrally formed with the rubber core, and the terminal component (14) is composed of a plurality of reeds or spring needles.

9. The modular illumination device according to claim 6, wherein the modular illumination device further comprises a PCB circuit board (15) installed on the connecting buckle clamp (9), one end of the PCB circuit board (15) is electrically connected to the first elastic contact connector (10), and the other end of the PCB circuit board is electrically connected to the second elastic contact connector (11).

10. The modular illumination device according to claim 6, wherein the plurality of electrical and signal connecting ports (5) of the multidirectional splicing lighting atmosphere illumination module are arranged in parallel, and the signal transmission of the two adjacent illumination modules adopts an unipolar return-to-zero code communication protocol.
